(19) United States
(12) Patent Application Publication
(10) Pub. No.: US 2015/0330428 A1
(43) Pub. Date: Nov. 19, 2015

(54) CATCH PORTION, APPARATUS AND MANUFACTURING METHOD OF CATCH PORTION

(71) Applicant: Kabushiki Kaisha Toshiba, Tokyo (JP)

(72) Inventors: Hiroaki Hirao, Ome Tokyo (JP); Tetsuo Okazaki, Hino Tokyo (JP); Naoki Tani, Ome Tokyo (JP)

(21) Appl. No.: 14/664,559

(22) Filed: Mar. 20, 2015

Related U.S. Application Data
(60) Provisional application No. 61/992,511, filed on May 13, 2014.

(51) Int. Cl. F16B 5/07; B23P 13/02

(52) U.S. Cl. CPC F16B 5/07; B23P 13/02

(57) ABSTRACT

According to one embodiment, a catch portion includes a thick-wall portion, a recessed portion, a first block and a second block. The thick-wall portion is formed inside an outer circumferential frame of a case configured to be open on at least one side. The recessed portion is provided in the thick-wall portion, and includes a first plane configured to face away from the open side of the case and a second plane configured to face toward the open side of the case. The first block protrudes from the thick-wall portion along the first plane. The second block protrudes more than the first block along the second plane.

### CROSS-REFERENCE TO RELATED APPLICATIONS

This application claims the benefit of U.S. Provisional Application No. 61/992,511, filed May 13, 2014, the entire contents of which are incorporated herein by reference.

### FIELD

Embodiments described herein relate generally to a catch portion, an apparatus and a manufacturing method of a catch portion.

### BACKGROUND

In some instances, as an engaging portion of the case of an electronic apparatus, etc., a hook is provided on one side, and a recessed portion corresponding to the hook is provided on the other side. Where the case is made from a flexible synthetic resin, the hook and recessed portion may be integrally formed by means of injection molding using a metallic mold. Where the case is cast from a lightweight alloy, the orientation of formation of the hook and recessed portion determines whether or not the hook and recessed portion can be integrally cast with the other portions.

Where the hook or recessed portion faces the outside in the direction crossing the direction in which the casting metallic mold is fitted, an integral formation may be possible depending on the structure of the metallic mold. However, this method is costly. Where the hook or recessed portion faces the inside in the direction crossing the direction in which the casting metallic mold is fitted, the hook or recessed portion is formed by a cutting work.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a disassembly perspective illustration of an apparatus including a catch portion of a first embodiment.

FIG. 2 is a cross-sectional view in which the catch portion of FIG. 1 fits a hook.

FIG. 3 is a perspective illustration showing the catch portion of FIG. 2.

FIG. 4 is a perspective illustration before the catch portion of FIG. 3 is processed.

FIG. 5 is a cross-sectional view of the catch portion of FIG. 3.

FIG. 6 is a cross-sectional view of the catch portion where the processing position of the catch portion of FIG. 3 is too deep.

FIG. 7 is a cross-sectional view of the catch portion where the processing position of the catch portion of FIG. 3 is too shallow.

FIG. 8 is a perspective illustration showing a catch portion of a second embodiment.

FIG. 9 is a perspective illustration before the catch portion of FIG. 6 is processed.

FIG. 10 is a perspective illustration showing a catch portion of a third embodiment.

FIG. 11 is a perspective illustration before the catch portion of FIG. 10 is processed.

### DETAILED DESCRIPTION

Various embodiments will be described hereinafter with reference to the accompanying drawings.

In general, according to one embodiment, a catch portion includes a thick-wall portion, a recessed portion, a first block and a second block. The thick-wall portion is formed inside an outer circumferential frame of a case configured to be open on at least one side. The recessed portion is provided in the thick-wall portion, and comprises a first plane configured to face away from the open side of the case and a second plane configured to face toward the open side of the case. The first block protrudes from the thick-wall portion along the first plane. The second block protrudes more than the first block along the second plane.

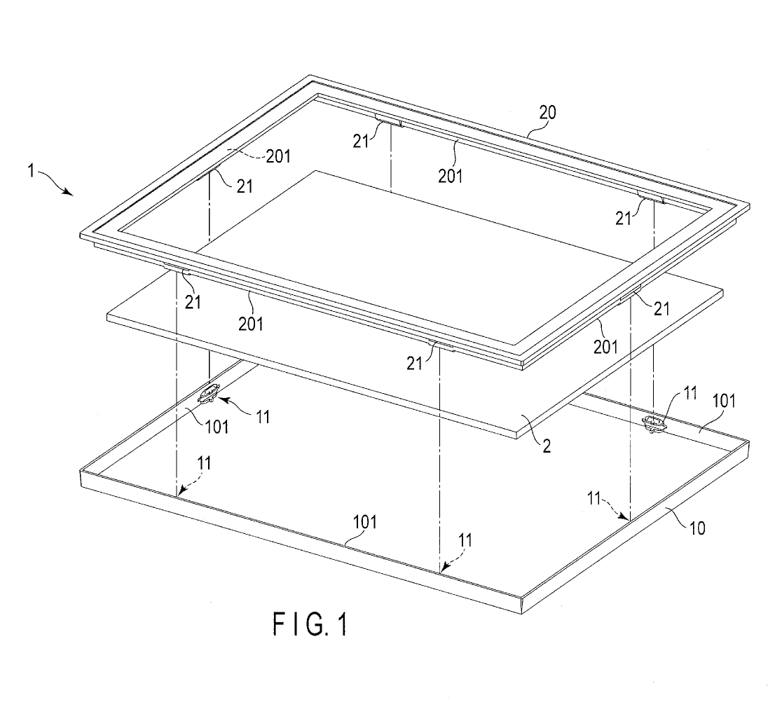

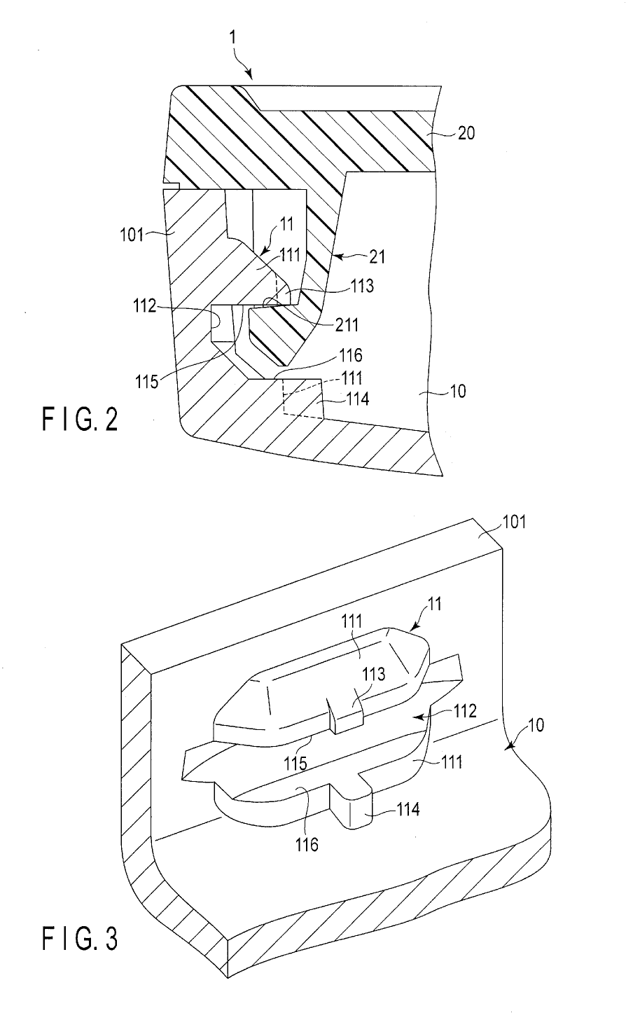

A catch portion 11 of a first embodiment is explained with reference to FIG. 1 to FIG. 7. As shown in FIG. 1, the catch portion 11 is adopted where a case 10 which is the outer shell of an apparatus 1 such as an electronic apparatus is attached to a cover 20 without a screw. In this embodiment, the apparatus 1 shown in FIG. 1 includes, for example, the case 10 configured to hold a display panel 2, and the cover 20 combined with the case 10. As shown in FIG. 2, the connecting portion of the case 10 and the cover 20 includes the catch portion 11 and a hook 21 configured to fit the catch portion 11. The catch portion 11 is provided in an outer circumferential frame 101 of the case 10. The hook 21 configured to fit the catch portion 11 is provided in the cover 20.

The case 10 is open on at least one side, and is cast into a shape comprising the outer circumferential frame 101 by a lightweight alloy (for example, a magnesium alloy). The case 10 comprises the catch portion 11 at a position close to a corner of the outer circumferential frame 101 and an exterior panel 102. In FIG. 1, the case 10 is a tray shaped like a thin rectangle. In the first embodiment, two catch portions 11 are provided on each long side of the case 10, and one catch portion 11 is provided in each short side of the case 10. The number of catch portions 11 and their positions are optimally determined depending on the size and shape of the case. The case 10 may comprise a rib for holding a display panel 2, a rib for reinforcement, or a rib having both functions.

The cover 20 is formed of a flexible synthetic resin and is attached in order to cover the open side of the case 10. Where the display panel 2 is provided inside the apparatus 1 as shown in FIG. 1, the cover 20 is formed into a frame shape and is mounted on the case 10 in order to press down the outer frame of the display panel 2. The cover 20 comprises a rib 201 on the inner surface. The rib 201 is formed in order to surround the outer circumference of the display panel 2. The hook 21 is formed at a position corresponding to the catch portion 11 in a part of the rib 201.

The catch portion 11 comprises a thick-wall portion 111, a recessed portion 112, a first block 113 and a second block 114 as shown in FIG. 3. The thick-wall portion 111 is formed inside the outer circumferential frame 101 of the case 10. The recessed portion 112 is formed in the thick-wall portion 111, and comprises a first plane 115 configured to face the deep side of the case 10 and a second plane 116 configured to face the open side of the case 10. The first block 113 protrudes from the thick-wall portion 111 along the first plane 115. The second block 114 protrudes from the thick-wall portion 111 along the second plane 116 more than the first block 113. In this embodiment, as shown in FIG. 3, the first block 113 and the second block 114 are formed in the substantially central portion of the thick-wall portion 111 along the outer circumferential frame 101, and extend in the direction away from the outer circumferential frame 101.

As shown in FIG. 2, the hook 21 comprises a third surface 211 making contact with the first plane 115 of the recessed portion 112 of the catch portion 11 in a state in which the cover 20 is mounted on the case 10. The hook 21 is formed larger than the thick-wall portion 111 in the direction along the outer circumferential frame 101 of the case 10. The third surface 211 is connected to the cover 20 outside the thick-wall portion 111. Thus, the hook 21 has a structure of a rib comprising a recessed portion surrounding the thick-wall portion 111 of the catch portion 11 which is provided on the open side of the case 10 compared with the first plane. In this embodiment, the hook 21 is formed in a part of the rib 201 provided on the inner surface of the cover 20.

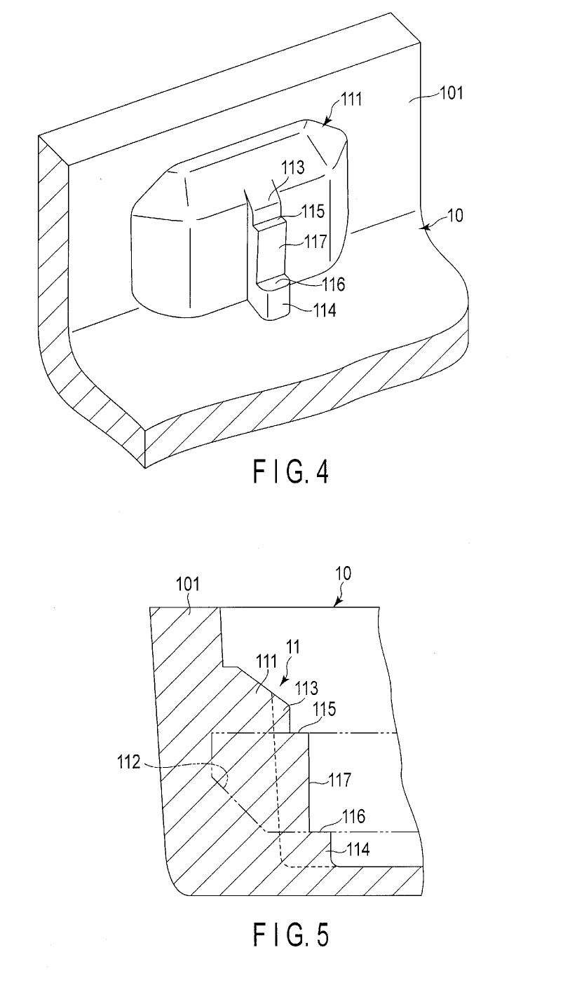

The recessed portion 112 of the catch portion 11 is formed by a cutting process after the thick-wall portion 111 is formed. FIG. 4 shows a perspective illustration of the thick-wall portion 111 before the recessed portion 112 is cut. FIG. 5 shows a cross-sectional view of the thick-wall portion 111 shown in FIG. 4. As shown in FIG. 4 and FIG. 5, in the thick-wall portion 111 before the recessed portion 112 is processed, an intermediate block 117 is formed between the first block 113 and the second block 114, or in other words, between the first plane 115 and the second plane 116. The intermediate block 117 protrudes more than the first block 113 and is smaller than the second block 114. The recessed portion 112 is processed by cutting. As a result, the intermediate block 117 is removed.

The intermediate block 117 has an end surface facing the first block 113. This end surface of the intermediate block 117 is formed in order to be the same plane as the first plane 115 of the recessed portion 112 formed by a cutting process as shown in FIG. 5. The first plane 115 of the recessed portion 112 defines a catching surface for the hook 21. Processing of the first plane 115 of the recessed portion 112 at the exact position where the end surface of the intermediate block 117 is removed enables the catching surface of the recessed portion 112 to be formed according to the set dimension. Further, the second block 114 has an end surface facing the intermediate block 117. This end surface which is the second plane 116 defines the removal range of the recessed portion 112. Cutting of the intermediate block 117 and a part of the thick-wall portion 111 along the second plane 116 enables the recessed portion 112 to be formed according to the set dimension.

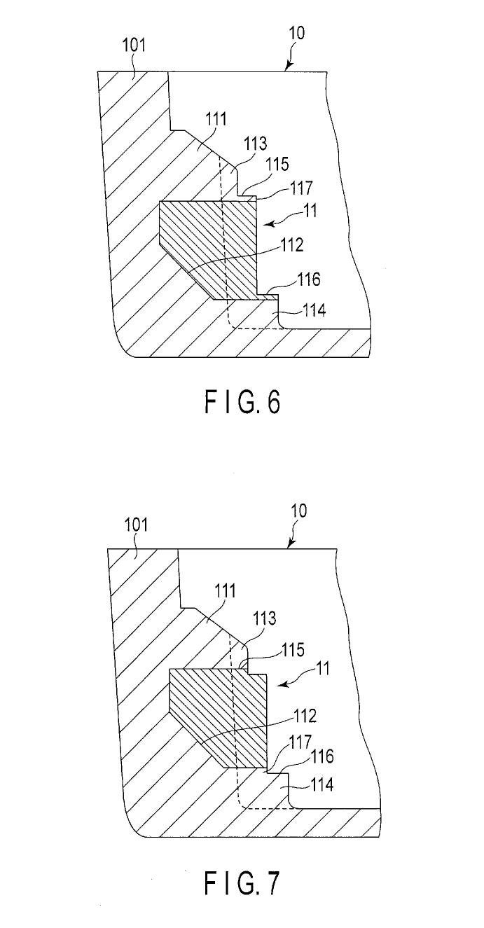

A cutting tool used for processing the recessed portion 112 comprises a blade which is shaped in such a way that the portion between the first plane 115 defining the catching surface and the second plane 116 defining the removal range can be cut at a time. Therefore, when the cutting tool is used along the second plane 116 in the cutting process, the first plane 115 is also formed. In other words, whether or not the first plane 115 is processed according to the set dimension can be easily determined by visually confirming the shape of the recessed portion 112. A method for this determination is shown in FIG. 6 and FIG. 7.

FIG. 6 shows a state in which the processing of the first plane 115 is insufficient. In FIG. 6, a part of the intermediate block 117 remains on the first block 113 side, and the second plane 116 of the second block 114 is cut. FIG. 7 shows the following state. In FIG. 7, a part of the intermediate block 117 remains on the second block 114 side, thereby producing a step 117A. In other words, the processing is not applied along the second plane 116, and the first block 113 is processed beyond the first plane 115. In both cases, it is possible to easily determine that the recessed portion 112 is not processed at the set position by means of a visual inspection. In the case of the catch portion 11 of FIG. 6, the first plane 115 of the recessed portion 112 can be processed again.

When the cover 20 is mounted on the case 10, the first block 113 rubs against the hook 21. However, since the protrusion size of the first block 113 is small and the hook 21 is sufficiently flexible, the assembly work is not disturbed. After the inspection of the processed portion, the first block 113 may be removed, or a recessed portion for avoiding the first block 113 may be provided in the hook 21. The provision of the recessed portion relatively determines the position of the hook 21 for the catch portion 11 in the direction along the outer circumferential frame 101.

As described above, according to the catch portion 11 of the first embodiment, where the recessed portion 112 of the catch portion 11 which is the engaging portion of the case 10 and the cover 20 is processed by cutting, an inspection work regarding whether or not the cutting process is applied in the predetermined manner can be easily conducted. Further, when the hook 21 of the cover 20 is mounted on the catch portion 11 of the case 10 which is manufactured through the above steps, the case 10 and the cover 20 are exactly combined with each other according to the set dimension.

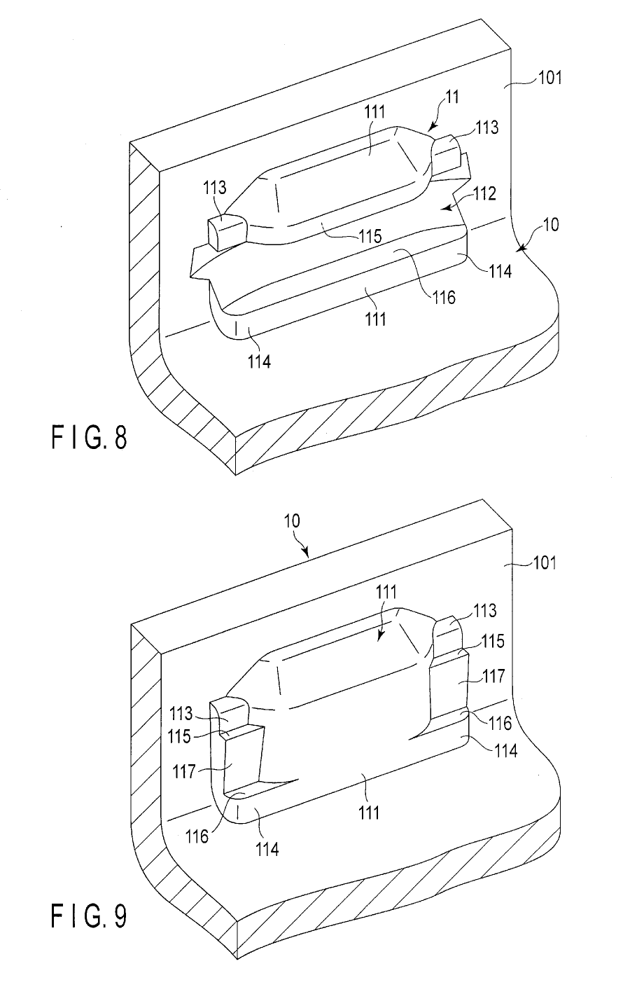

A catch portion 11 of a second embodiment is explained with reference to FIG. 8 and FIG. 9. Structures having the same functions as the catch portion 11 of the first embedment will be denoted by the same reference numbers in the following explanations and drawings in the second embodiment. For detailed explanations, corresponding descriptions in the first embodiment should be referred to.

As shown in FIG. 8, the catch portion 11 of the second embodiment comprises a first block 113 and a second block 114 in such a way that the first block 113 and the second block 114 extend from both ends of a thick-wall portion 111 in the direction along an outer circumferential portion 101 of a case 10. Therefore, in the case 10 in which the catch portion 11 of the second embodiment is formed, an intermediate block 117 is provided between the first block 113 and the second block 114 in a state before a recessed portion 112 of the catch portion 11 is formed by a cutting process.

As shown in FIG. 9, between a first plane 115 and a second plane 116, the intermediate block 117 protrudes more than the first block 113 in the direction away from the outer circumferential frame 101, and is smaller than the second block 114. The first block 113, the intermediate block 117 and the second block 114 are formed like descending stairs in the direction away from the outer circumferential frame 101. Like the first embodiment, formation of the recessed portion 112 by a cutting process to remove the intermediate block 117 enables easy determination as to whether or not the set position and the set dimension are achieved. Even if the first block 113 and the second block 114 remain after the processing of the intermediate block 117, a hook 21 fits the recessed portion 112 of the catch portion 11 without interference with the first block 113 and the second block 114 when the cover 20 is mounted on the case 10.

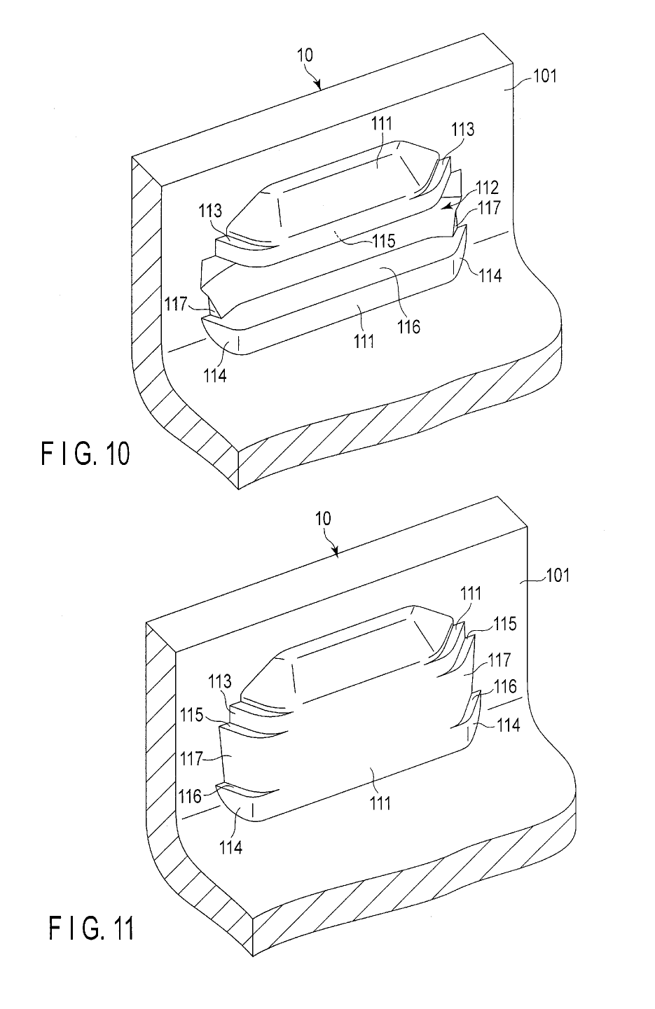

A catch portion 11 of a third embodiment is explained with reference to FIG. 10 and FIG. 11. Structures having the same functions as the catch portion 11 of the first and second embodiments will be denoted by the same reference numbers in the following explanations and drawings in the third embodiment. For detailed explanations, corresponding descriptions in the first and second embodiments should be referred to.

As shown in FIG. 10, the catch portion 11 of the third embodiment comprises a first block 113 and a second block 114 in such a way that the first block 113 and the second block 114 extend from both ends of a thick-wall portion 111 in the direction along an outer circumferential portion 101 of a case 10. Therefore, like the second embodiment, in the case 10 in which the catch portion 11 of the third embodiment is formed, an intermediate block 117 is provided between the first block 113 and the second block 114 in a state before a recessed portion 112 of the catch portion 11 is formed by a cutting process.

At this time, in the third embodiment, the first block 113, the intermediate block 117 and the second block 114 are formed like stairs in the direction away from the thick-wall portion 111 as shown in FIG. 11. In the third embodiment, like the first and second embodiments, formation of the recessed portion 112 by a cutting process to remove the intermediate block 117 enables easy determination as to whether or not the set position and the set dimension are achieved.

In the first to third embodiments, the first block 113 may not be provided. If the intermediate block 117 is provided in such a way that the intermediate block 117 protrudes more than the thick-wall portion 11 along the first plane 115 before the recessed portion 112 of the catch portion 11 is processed, a remaining portion of the intermediate block 117 along the first plane 115 enables visual confirmation that the processed recessed portion 112 deviates to the deep side of the case 10 as shown in FIG. 6. A remaining step between the second block 114 and the recessed portion 112 as shown in FIG. 7 enables visual confirmation that the processed recessed portion 112 deviates to the open side of the case 10.

In the first to third embodiments, a hole or groove may be provided in the first block 113 from the open side of the case 10 in such a way that the hole or groove has a bottom portion at a position which is the maximum allowable common difference where the formed recessed portion 112 deviates to the open side of the case 10 relative to the design processing position of the recessed portion 112. Similarly, a hole or groove may be provided in the second block 114 from the open side of the case 10 in such a way that the hole or groove has a bottom portion at a position which is the maximum allowance difference where the formed recessed portion 112 deviates to the deep side of the case 10 relative to the design processing position of the recessed portion. The structure comprising the holes or grooves enables determination regarding whether or not the recessed portion 112 is allowable for the processing common difference.

For example, if the bottom of the hole or groove of the first block 113 is cut through the processing of the recessed portion 112, this case shows that the recessed portion 112 deviates to the open side. If the bottom of the hole or groove of the second block 114 is cut, this case shows that the recessed portion 112 deviates to the deep side. These holes or grooves may be provided in the thick-wall portion 111 from the open side instead of in the first block 113 and the second block 114.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A catch portion comprising:
a thick-wall portion inside an outer circumferential frame of a case configured to be open on at least one side;
a recessed portion in the thick-wall portion, the recessed portion comprising a first plane configured to face away from the open side of the case and a second plane configured to face toward the open side of the case;
a first block configured to protrude from the thick-wall portion along the first plane; and
a second block configured to protrude more than the first block along the second plane.

2. The catch portion of claim 1, wherein
the first block and the second block extend in a direction away from the outer circumferential frame.

3. The catch portion of claim 1, wherein
the first block and the second block are in at least one end portion of the thick-wall portion along the outer circumferential frame.

4. An apparatus comprising:
a case configured to be open on at least one side, the case comprising an outer circumferential frame;
a catch portion inside the outer circumferential frame, the catch portion comprising:
a thick-wall portion inside the outer circumferential frame;
a recessed portion in the thick-wall portion, the recessed portion comprising a first plane configured to face away from the open side of the case and a second plane configured to face toward the open side of the case;
a first block configured to protrude from the thick-wall portion along the first plane; and
a second block configured to protrude more than the first block along the second plane;
a cover configured to cover the open side of the case; and
a hook in the cover configured to fit in the recessed portion.

5. The apparatus of claim 4, wherein
the first block and the second block extend in a direction away from the outer circumferential frame.

6. The apparatus of claim 4, wherein
the first block and the second block are provided in at least one end portion of the thick-wall portion along the outer circumferential frame.

7. A manufacturing method of a catch portion comprising:
forming a thick-wall portion inside an outer circumferential frame of a case configured to be open on at least one side, a first block configured to protrude from the thick-wall portion along a first plane defining a catching surface of a recessed portion of the catch portion on an open side of the case, a second block configured to protrude more than the first block along a second plane defining an removal range of the recessed portion of the catch portion on a side away from the open side of the case, and an intermediate block configured to protrude more than the first block and to be smaller than the second block between the first plane and the second plane; and
machining to remove a part of the thick-wall portion and the intermediate block between the first plane and the second plane.

8. The manufacturing method of claim 7, wherein
the first block, the intermediate block and the second block are like stairs in a direction away from the outer circumferential frame.

9. The manufacturing method of claim 7, wherein
the first block, the intermediate block and the second block are in at least one end portion of the thick-wall portion along the outer circumferential frame.

10. The manufacturing method of claim 9, wherein
the first block, the intermediate block and the second block are like stairs in a direction away from the outer circumferential frame.

11. The manufacturing method of claim 9, wherein
the first block, the intermediate block and the second block are like stairs in a direction away from the thick-wall portion along the outer circumferential frame.
